(19) United States
(12) Patent Application Publication
(10) Pub. No.: US 2023/0250958 A1
(43) Pub. Date: Aug. 10, 2023

(54) COMBUSTOR NOZZLE FOR REDUCTION IN COMBUSTION VIBRATION, AND GAS TURBINE INCLUDING SAME

(71) Applicant: DOOSAN ENERBILITY CO., LTD., Changwon (KR)

(72) Inventors: Han Jin JEONG, Hanam (KR); Seong Hwi JO, Daejeon (KR); Chea Hong CHOI, Gimhae (KR)

(21) Appl. No.: 18/161,624

(22) Filed: Jan. 30, 2023

(30) Foreign Application Priority Data
Feb. 9, 2022 (KR) 10-2022-0016780

(51) Int. Cl. F23R 3/28

(52) U.S. Cl. CPC F23R 3/286; F23R 2900/00014

(57) ABSTRACT

A combustor nozzle includes at least one cluster composed of a plurality of tubes through which air and fuel flow, the cluster including a main tube through which the air and fuel flows, and a plurality of sub-tubes disposed to surround the main tube, wherein a diameter of the main tube and a diameter of at least one of the plurality of sub-tubes are different.

### CROSS REFERENCE TO RELATED APPLICATION

The present application claims priority to Korean Patent Application No. 10-2022-0016780, filed on Feb. 9, 2022, the entire contents of which are incorporated herein for all purposes by this reference.

### BACKGROUND OF THE INVENTION

### 1. Field of the Invention

The present disclosure relates to a combustor nozzle for reduction in combustion vibration, and a gas turbine including the same.

### 2. Description of the Background Art

A turbine is a machine that obtains rotational force with an impulsive force or reaction force using a flow of compressive fluids such as steam and gas, and such turbines include a steam turbine using steam, a gas turbine using high temperature combustion gas, or the like.

A gas turbine is a combustion engine in which a mixture of air compressed by a compressor and fuel is combusted to produce a high temperature gas, which drives a turbine. The gas turbine is used to drive electric generators, aircraft, ships, trains, or the like.

The gas turbine generally includes a compressor, a combustor, and a turbine. The compressor serves to intake external air, compress the air, and transfer the compressed air to the combustor. The compressed air compressed by the compressor has a high temperature and a high pressure. The combustor serves to mix compressed air from the compressor and fuel and combust the mixture of compressed air and fuel to produce combustion gases, which are discharged to the gas turbine. The combustion gases drive turbine blades in the turbine to produce power. The power generated through the above processes is applied to a variety of fields such as generation of electricity, driving of mechanical units, etc.

Fuel is injected through nozzles disposed in respective combustors, wherein the fuel includes gaseous fuel and liquid fuel. In recent years, in order to suppress the emission of carbon dioxide, use of hydrogen fuel or a fuel containing hydrogen is recommended.

However, since hydrogen has a high combustion rate, when such fuels are burned with a gas turbine combustor, flames formed in the gas turbine combustor approach and heat the structure of the gas turbine combustor, thereby degrading the reliability of the gas turbine combustor.

To solve this problem, a combustor with multiple tubes is being proposed. However, these multiple tubes can cause vibration due to a vortex of fuel injected from respective tubes, and if the shapes and injection directions of the tubes are the same, the same phases are merged to increase the amplitude of the vibration.

The foregoing is intended merely to aid in the understanding of the background of the present disclosure, and is not intended to mean that the present disclosure falls within the purview of the related art that is already known to those skilled in the art.

### SUMMARY OF THE INVENTION

Accordingly, the present disclosure has been made keeping in mind the above problems occurring in the related art, and an objective of the present disclosure is to provide a combustor nozzle in which a plurality of tubes has different diameters and is arranged irregularly so that the amplitude amplification of combustion vibration due to merger of the same phases can be reduced, and a gas turbine including the same.

In addition, another objective of the present disclosure is to provide a combustor nozzle in which the amplitude amplification of combustion vibration is reduced so that the combustion instability can be reduced, and a gas turbine including the same.

In an aspect of the present disclosure, there is provided a combustor nozzle including: at least one cluster composed of a plurality of tubes through which air and fuel flow, the cluster including a main tube through which the air and fuel flows, and a plurality of sub-tubes disposed to surround the main tube, wherein a diameter of the main tube and a diameter of at least one of the plurality of sub-tubes are different.

The cluster may be composed of a central cluster and at least one peripheral clusters placed to surround the central cluster.

The diameter of the main tube may be 2-5 times the diameter of the at least one of the plurality of sub-tubes.

The plurality of sub-tubes may have the same diameter.

Distances between pairs of adjacent sub-tubes of the plurality of sub-tubes may be the same.

The center of the main tube may deviate in one direction from the center of the cluster.

The distances between pairs of adjacent sub-tubes of the plurality of sub-tubes may increase along a clockwise or counterclockwise direction.

The plurality of sub-tubes may have different diameters.

The diameters of the plurality of sub-tubes may decrease along a clockwise or counterclockwise direction.

The distances from the center of the main tube to the centers of the plurality of sub-tubes may be different.

In another aspect of the present disclosure, there is provided a gas turbine including a compressor configured to compress air introduced from the outside, a combustor having a combustor nozzle and configured to mix the compressed air compressed in the compressor and fuel and combust an air-fuel mixture, and a turbine including a plurality of turbine blades to be rotated by combustion gases combusted in the combustor, the combustor nozzle including at least one cluster composed of a plurality of tubes through which air and fuel flow, the cluster including a main tube through which the air and fuel flows, and a plurality of sub-tubes disposed to surround the main tube, wherein a diameter of the main tube and a diameter of at least one of the plurality of sub-tubes are different.

The cluster may be composed of a central cluster and at least one peripheral clusters placed to surround the central cluster.

The diameter of the main tube may be 2-5 times the diameter of the at least one of the plurality of sub-tubes.

The plurality of sub-tubes may have the same diameter.

Distances between pairs of adjacent sub-tubes of the plurality of sub-tubes may be the same.

The center of the main tube may deviate in one direction from the center of the cluster.

The distances between pairs of adjacent sub-tubes of the plurality of sub-tubes may increase along a clockwise or counterclockwise direction.

The plurality of sub-tubes may have different diameters.

The diameters of the plurality of sub-tubes may decrease along a clockwise or counterclockwise direction.

The distances from the center of the main tube to the centers of the plurality of sub-tubes may be different.

As described above, according to the present disclosure, in the combustor nozzle and the gas turbine, the plurality of tubes has different diameters and is arranged irregularly so that the amplitude amplification of combustion vibration due to merger of the same phases can be reduced.

In addition, according to the present disclosure, in the combustor nozzle and the gas turbine, the amplitude amplification of combustion vibration is reduced so that the combustion instability can be reduced.

### BRIEF DESCRIPTION OF THE DRAWINGS

FIG. 1 is a view illustrating the interior of a gas turbine according to a first embodiment of the present disclosure;

FIG. 2 is a longitudinal sectional view illustrating a combustor of FIG. 1;

FIG. 3 is an enlarged view illustrating a combustor nozzle of FIG. 2;

FIG. 4 is an enlarged view illustrating a cluster of FIG. 3;

FIG. 5 is a schematic cross-sectional view illustrating a main tube of FIG. 4;

FIG. 6 is a view illustrating a variation of the cluster of FIG. 4;

FIG. 7 is an enlarged view illustrating a combustor nozzle according to a second embodiment of the present disclosure;

FIG. 8 is an enlarged view illustrating a cluster of FIG. 7;

FIG. 9 is a view illustrating a cluster according to a third embodiment of the present disclosure; and

FIG. 10 is a view illustrating a cluster according to a fourth embodiment of the present disclosure.

### DETAILED DESCRIPTION OF THE INVENTION

Hereinafter, exemplary embodiments of the present disclosure will be described in detail with reference to the accompanying drawings. However, it should be noted that the present disclosure is not limited thereto, but may include all of modifications, equivalents or substitutions within the spirit and scope of the present disclosure.

Terms used herein are used to merely describe specific embodiments, and are not intended to limit the present disclosure. As used herein, an element expressed as a singular form includes a plurality of elements, unless the context clearly indicates otherwise. Further, it will be understood that the terms “comprising” or “including” specifies the presence of stated features, numbers, steps, operations, elements, parts, or combinations thereof, but does not preclude the presence or addition of one or more other features, numbers, steps, operations, elements, parts, or combinations thereof. Hereinafter, preferred embodiments of the present disclosure will be described in detail with reference to the accompanying drawings.

Hereinafter, preferred embodiments of the present disclosure will be described in detail with reference to the accompanying drawings. It is noted that like elements are denoted in the drawings by like reference symbols as whenever possible. Further, the detailed description of known functions and configurations that may obscure the gist of the present disclosure will be omitted. For the same reason, some of the elements in the drawings are exaggerated, omitted, or schematically illustrated.

Hereinafter, a gas turbine 1000 according to an embodiment of the present disclosure will be described.

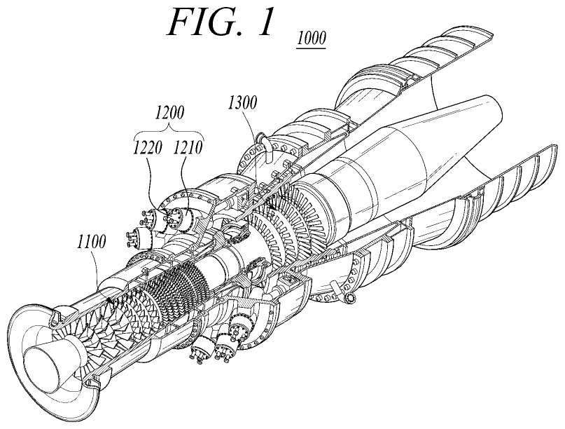

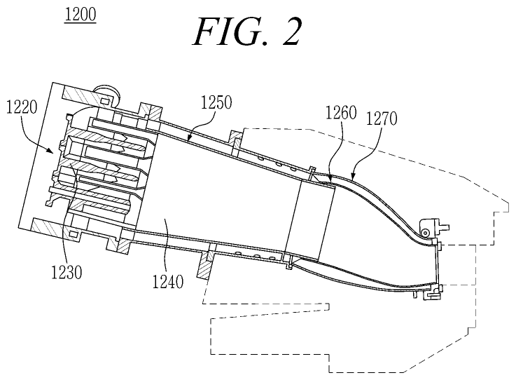

FIG. 1 is a view illustrating the interior of a gas turbine according to an embodiment of the present disclosure, and FIG. 2 is a longitudinal sectional view illustrating a combustor of FIG. 1.

An ideal thermodynamic cycle of a gas turbine 1000 according to the present embodiment follows a Brayton cycle. The Brayton cycle consists of four thermodynamic processes: isentropic compression (adiabatic compression), isobaric combustion, isentropic expansion (adiabatic expansion) and isobaric heat ejection. That is, in the Brayton cycle, atmospheric air is sucked and compressed into high pressure air, mixed gas of fuel and compressed air is combusted at constant pressure to discharge heat energy, heat energy of hot expanded combustion gas is converted into kinetic energy, and exhaust gases containing remaining heat energy is discharged to the outside. That is, gases undergo four thermodynamic processes: compression, heating, expansion, and heat ejection.

As illustrated in FIG. 1, the gas turbine 1000 employing the Brayton cycle includes a compressor 1100, a combustor 1200, and a turbine 1300. Although the following description will be described with reference to FIG. 1, the present disclosure may be widely applied to other turbine engines similar to the gas turbine 1000 illustrated in FIG. 1.

Referring to FIGS. 1 and 2, the compressor 1100 of the gas turbine 1000 may suck and compress external air. The compressor 1100 may serve both to supply the compressed air by compressor blades to a combustor 1200 and to supply the cooling air to a high temperature region of the gas turbine 1000. Here, since the sucked air undergoes an adiabatic compression process in the compressor 1100, the air passing through the compressor 1100 has increased pressure and temperature.

The compressor 1100 is usually designed as a centrifugal compressor or an axial compressor, and the centrifugal compressor is applied to a small-scale gas turbine, whereas a multi-stage axial compressor 1100 is applied to a large-scale gas turbine 1000 illustrated in FIG. 1 since the large-scale gas turbine 1000 is required to compress a large amount of air.

The compressor 1100 is driven using a portion of the power output from the turbine 1300. To this end, as illustrated in FIG. 1, the rotary shaft of the compressor 1100 and the rotary shaft of the turbine 1300 are directly connected. In the case of the large-scale gas turbine engine 1000, almost half of the output produced by the turbine 1300 is consumed to drive the compressor 1100. Accordingly, improving the efficiency of the compressor 1100 has a direct effect on improving the overall efficiency of the gas turbine engine 1000.

On the other hand, the combustor 1200 serves to mix the compressed air supplied from an outlet of the compressor 1100 with fuel and combust the mixture at constant pressure to produce hot combustion gases. The combustor 1200 mixes the introduced compressed air with fuel and combusts the air-fuel mixture to produce high-energy, high-temperature and high-pressure combustion gases, and increases the temperature of the combustion gases to the heat resistant limit at which the combustor and turbine parts can withstand heat through an isobaric combustion process.

A plurality of combustors 1200 may be arranged in a housing formed in the form of a cell, and each of the combustors include a burner containing a fuel injection nozzle, a combustor liner forming a combustion chamber, and a transition piece that is a connection between the combustor and the turbine.

The combustor 1200 is disposed on the downstream of the compressor 1100 such that a plurality of burners 1220 is disposed along an annular combustor casing 1210. Each burner 1220 is provided with several combustion nozzles 1230, and fuel injected from the combustion nozzles 1230 is mixed with the compressed air in an appropriate ratio suitable for combustion. The fuel injected from the fuel nozzles 1230 is mixed with the compressed air and then enters the combustion chamber 1240.

Since the combustor 1200 has the highest-temperature environment in the gas turbine engine 1000, the combustor requires appropriate cooling. Referring to FIGS. 1 and 2, a duct assembly connecting the burner 1220 and the turbine 1300 so that a high temperature combustion gas flows therethrough, that is, a duct assembly composed of a liner 1250 and the transition piece 1260, and a flow sleeve 1270 is provided such that the compressed air flows along an outer surface of the duct assembly to the combustion nozzle 1230, so that the duct assembly heated by a high temperature combustion gas is properly cooled.

The combustion machine 1200 may include at least one cluster 1500 consisting of a plurality of tubes through which air and fuel flow.

High-temperature and high-pressure combustion gas produced by the combustor 1200 is supplied to the turbine 1300 through the duct assembly.

The turbine 1300 may include a plurality of turbine blades rotated by the combustion gas combusted in the combustor 1200. In the turbine 1300, the combustion gas adiabatically expands and provides an impact and reaction force to turbine blades radially arranged on the rotary shaft of the turbine 1300 so that thermal energy of the combustion gas is converted into a mechanical energy in which the rotary shaft is rotated. A portion of the mechanical energy obtained from the turbine 1300 is used to compress air in the compressor, and the rest is used as an effective energy for driving a generator to produce power, for example.

Hereinafter, a combustor nozzle 1230 according to a first embodiment of the present disclosure will be described.

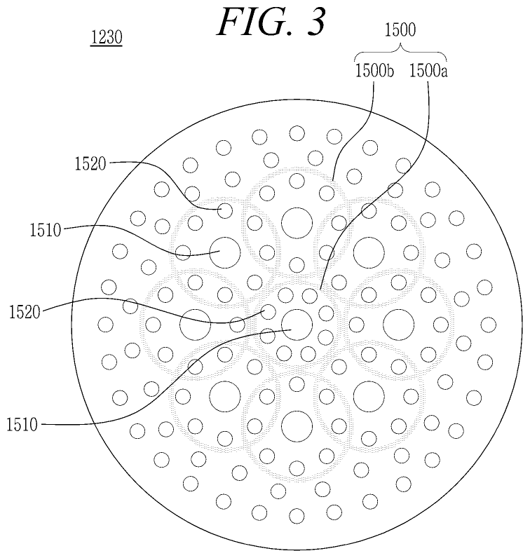

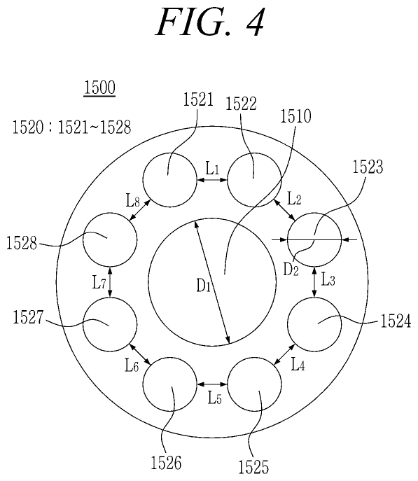

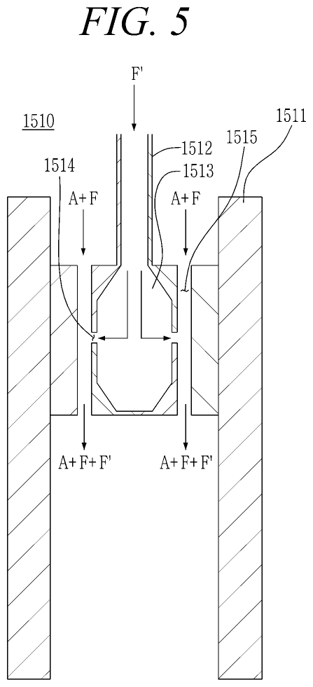

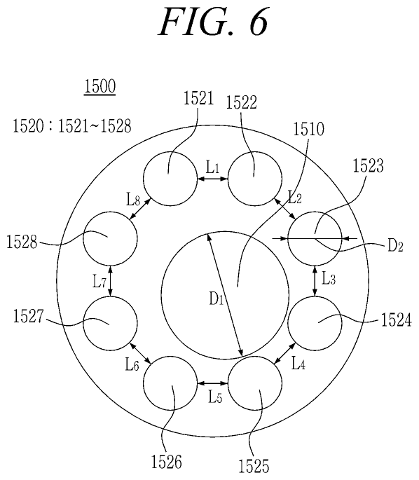

FIG. 3 is an enlarged view illustrating the combustor nozzle of FIG. 2. FIG. 4 is an enlarged view illustrating a cluster of FIG. 3. FIG. 5 is a schematic cross-sectional view illustrating a main tube of FIG. 4. FIG. 6 is a view illustrating a variation of the cluster of FIG. 4.

Referring to FIGS. 3 to 6, the combustion nozzle 1230 according to the first embodiment of the present disclosure may include at least one cluster 1500 consisting of a plurality of tubes through which air and fuel flow.

At least one of the clusters 1500 of the combustion nozzle 1230 may be replaceable. Accordingly, if some of the plurality of tubes do not function or the combustor nozzle 1230 is aged and requires to be replaced, only corresponding cluster 1500, rather than the whole combustor nozzle 1230, may be replaced.

The clusters 1500 may include a central cluster 1500a and one or more peripheral clusters 1500b. The central cluster 1500a and the peripheral clusters 1500b may be replaced or removed individually.

The central cluster 1500a may be located at the center of the combustor nozzle 1230 when the combustor nozzle is viewed from a longitudinal or axial direction according to the flow of fuel and air therein. The peripheral clusters 1500b may be placed around the central cluster 1500a.

Each cluster 1500 may include a main tube 1510 and one or more sub-tubes 1520. The main tube 1510 may be disposed at the center of the cluster 1500 and the sub-tubes 1520 may be disposed around and surrounding the main tube 1510. Here, it can be understood by the ordinary skilled person in the art associated with this embodiment that other conventional components may be further included in the cluster 1500 in addition to the components illustrated in FIGS. 3 to 6.

The main tube 1510 may include an outer tube part 1511, a fuel supply part 1512, a fuel distribution part 1513, a distribution hole 1514, and an injection tube part 1515 (see FIG. 5). Here, the main tube 1510 may serve as a passage for air and fuel. The main tube 1510 may be located at the center of the cluster 1500. The main tube 1510 may have a diameter that may vary depending on the injection and mixing states of the fuel and air.

According to an embodiment, in the main tube 1510, independently of the sub-tubes 1520, fuel may be supplied by the fuel supply part 1512, so the equivalent ratio of the mixed fuel injected from the main tube 1510 and the sub-tube 1520 may be different and may be controlled to be different.

According to an embodiment, when a premixed air-fuel mixture that is obtained by previously mixing air and fuel is supplied to the main tube 1510 and the sub-tube 1520, fuel may be additionally supplied, by the fuel supply part 1512, to the premixed air-fuel mixture that was supplied to the main tube 1510, thereby a high equivalent ratio of fuel may be injected from the main tube 1510 to the combustion chamber 1240.

When the combustor 1200 is operated with the combustion of a low equivalent ratio of premixed air-fuel mixture injected from the sub-tube 1520, the flame temperature may be low due to the low equivalent ratio. As a result, unburned hydro-carbon (UHC) or carbon monoxide may occur, and combustion vibration may occur due to the flame instability. However, if the main tube 1510 additionally provides a high equivalent ratio of fuel, the flame temperature or the combustion vibration may be controlled.

In addition, the main tube 1510 may serve as a pilot burner that supplies a high equivalent ratio of fuel for the initial start of the combustor 1200.

According to an embodiment, the diameter D1 of the main tube 1510 may be different from the diameter D2 of the sub-tube 1520. The diameter D1 of the main tube 1510 may be larger than the diameter D2 of the sub-tube 1520. The phase according to the combustion of the fuel injected from the main tube 1510 and the phase according to the combustion of the fuel injected from the sub-tube 1520 may be different to each other, since the diameter D1 of the main tube 1510 is different from the diameter D2 of the sub-tube 1520.

As a result, the degree of flame overlap according to the combustion of fuel can be reduced. In addition, the amplification of vibration amplitude occurring due to the merge of the same phases of the combustion vibration according to the fuel combustion may be prevented due to different phases. As the phases of the combustion vibration are different, the phases are offset together, thereby reducing the amplification of amplitude. As the combustion vibration decreases, the combustion instability during driving of the combustor 1200 may be also reduced.

According to an embodiment, the diameter D1 of the main tube 1510 may be 2 to 5 times the diameter D2 of the sub-tube 1520. If the diameter D1 of the main tube 1510 is less than twice the diameter D2 of the sub-tube 1520, and a difference in the diameter between the main tube 1510 and the sub-tube 1520 is not large enough, then the phase and the amplitude of the combustion vibration may be similar. Accordingly, in such case, the similar phases of the combustion vibration may be merged to amplify the amplitude of the combustion vibration.

If the diameter D1 of the main tube 1510 exceeds 5 times the diameter D2 of the sub-tube 1520, the diameter D1 of the main tube 1510 may be excessively larger than the diameter D2 of the sub-tube 1520. When the diameter D1 of the main tube 1510 is too large than the diameter D2 of the sub-tube 1520, the number of main tube 1510 and sub-tubes 1520 that may be provided in a limited area of the cluster 1500 may decrease.

In addition, if the cross-sectional area of the main tube 1510 is too large, then the injection speed of the fuel injected from the main tube 1510 may be reduced too much. If injection speed of the fuel injected from the main tube 1510 is too much reduced, flames caused by the fuel combustion may be formed closer to the main tube 1510, so there may be a risk of damage to the main tube 1510 due to the high temperature.

Air and fuel may flow through the inside of the outer tube part 1511. The outer tube part 1511 may be a tubular part having an internal space through which air and fuel may flow. The outer tube 1511 may be a tubular part having a diameter sufficient to form the fuel supply part 1512, the fuel distribution part 1513, and the injection tube part 1515 therein. According an embodiment, an initial mixture of air and fuel may flow through the inside of the outer tube part 1511, while through the fuel supply part 1512 contained in the outer tube part 1511, only the additional fuel flows. The outer tube part 1511 may be made of a heat resistant material that can withstand high temperature to prevent damage caused by the fuel flashback.

The fuel supply part 1512 may supply fuel into the outer tube part 1511. The fuel supply part 1512 may be a tubular part having an internal space through which fuel may flow. According to an embodiment, the fuel supply part 1512 may be connected to the center of the fuel distribution part 1513 described later to supply fuel thereto.

According to an embodiment, the fuel distribution part 1513 is located inside the outer tube part 1511 and may be connected to the fuel supply part 1512 to receive the supplied additional fuel and distribute the supplied fuel into the outer tube part 1511 (see FIG. 5). The fuel distribution part 1513 may be fixed in the center of the outer tube 1511. The fuel distribution part 1513 may be fixed to the center of the outer tube part 1511 so as to prevent the fuel in the main tube 1510 from being collected in one direction. Accordingly, it is possible to prevent damage to the combustor caused by the flashback.

According to an embodiment, the fuel distribution part 1513 may be a box body in which an internal space for fuel is formed and a distribution hole 1514 connected to the injection tube part 1515 is formed. However, the shape of the fuel distribution part 1513 may not be limited thereto, but may be changed by an ordinary skilled person in the art.

The fuel distribution part 1513 may be fixed at a position closer to a rear end than a front end of the outer tube part 1511. In other words, the fuel distribution part 1513 may be disposed at a position closer to the upstream end than the downstream end of the outer tube part 1511 according to the flow direction of the fuel. The longer the distance between the fuel distribution part 1513 and the front end of the outer tube part 1511, the longer the route in which the injected fuel may be mixed with air until the fuel is burned. Thereby, the injected fuel may be sufficiently mixed with the air.

The fuel distribution part 1513 may include a distribution hole 1514. According to an embodiment, the distribution hole 1514 may have the same diameter with the diameter of each injection tube part 1515. According to an embodiment, the fuel distribution part 1513 may include a plurality of distribution holes 1514, each of them having a same diameter each other.

The distribution hole 1514 is a hole that connects the fuel distribution part 1513 and the injection tube part 1515, and may serve as a passage for delivering fuel from the fuel distribution part 1513 to the injection tube part 1515. According to an embodiment, the distribution hole 1514 may have the same diameter with the diameter of each injection tube part 1515 so that the same amount of fuel may be distributed to the plurality of injection tube parts 1515. According to an embodiment, the fuel distribution part 1513 may include a plurality of distribution holes 1514, each of them having a same diameter each other. However, the diameter of the distribution hole 1514 may be changed according to the injection and mixing states of air and fuel.

The distribution hole 1514 may be formed at the longitudinally middle position of the injection tube part 1515. However, since the location of the distribution hole 1514 is related to the length of the mixing route of the air and the distributed fuel, the location of the distribution hole may be changed according to the length of the necessary mixing route.

The injection tube part 1515 is located inside the outer tube part 1511 and may be connected to the fuel distribution part 1513 to inject the distributed fuel. The injection tube part 1515 may be a tubular part having an internal space through which air and fuel flow. The injection tube part 1515 may be made of a heat resistant material that can withstand high temperature to prevent damage caused by the fuel flashback.

According to an embodiment, the injection tube part 1515 may be arranged around the fuel distribution part 1513 and at least one injection tube parts 1515 may be provided. According to an embodiment, the injection tube part 1515 may be arranged at the same central angle from the center of the fuel distribution part 1513. The plurality of injection tube parts 1515 may be arranged at the same central angle about the fuel distribution part 1513 while surrounding the fuel distribution part 1513. The injection tube parts 1515 may be arranged at the same distance from the center of the fuel distribution part 1513. The plurality of injection tube parts 1515 may be arranged such that each of the injection tube part 1515 is spaced with the same distance from an adjacent injection tube part 1515.

Since the injection tube parts 1515 are arranged at the same central angle at the same distance from the fuel distribution part 1513 as shown above, the same amount of fuel may be distributed by the fuel distribution part 1513 to each injection tube part 1515 without a special device. However, the placement of the injection tube parts 1515 may not be limited to the above arrangement, but may be changed as needed.

The injection tube part 1515 may be an extended cylindrical shape having the same diameter. In other words, according to an embodiment, the injection tube part 1515 may be formed such that the diameter of the injection tube part 1515 may remain the same from its inlet to its outlet along the flow direction of the fuel. However, as described later, inlet and outlet of the injection tube part 1515 may be changed as needed.

According to an embodiment, the sub-tubes 1520 may include a first sub-tube 1521, a second sub-tube 1522, a third sub-tube 1523, a fourth sub-tube 1524, a fifth sub-tube 1525, a sixth sub-tube 1526, a seventh sub-tube 1527, and an eighth sub-tube 1528 (see FIG. 4). However, here, the first to eighth sub-tube 1521, 1522, 1523, 1524, 1525, 1526, 1526, 1527, and 1528 are only examples of the sub-tube 1520, and the number of the sub-tubes 1520 may be changed as needed.

The sub-tubes 1520 may be disposed around the main tube 1510. The sub-tubes 1520 may be located inside the cluster 1500 surrounding the main tube 1510. The sub-tubes 1520 may be passages for fuel and air. The diameter of the sub-tubes 1520 may vary depending on the injection and mixing states of the fuel and air.

According to an embodiment, the diameter D2 of the sub-tube 1520 may be different from the diameter D1 of the main tube 1510. The diameter D2 of the sub-tube 1520 may be smaller than the diameter D1 of the main tube 1510. When the diameter D2 of the sub-tube 1520 and the diameter D1 of the main tube 1510 are different, the amplification of vibration amplitude occurring due to the merge of the same phases of the combustion vibration according to the fuel combustion may be prevented due to different phases. Also, as the phases of the combustion vibration are different, the phases may be offset together, thereby reducing the amplification of amplitude and the combustion instability.

According to an embodiment, the diameters D2 of the sub-tubes 1520 may be all the same. Since the diameters D2 of the plurality of sub-tubes 1520 are all the same while being different from the diameter D1 of the main tube 1510, the phases of the combustion vibration may be different, and at the same time, the structure of the cluster 1500 may be simplified.

According to an embodiment, the distances between pairs of adjacent sub-tubes 1520 may be the same. That is, a first distance L1 between the first sub-tube 1521 and the second sub-tube 1522, a second distance L2 between the second sub-tube 1522 and the third sub-tube 1523, a third distance L3 between the third sub-tube 1523 and the fourth sun-tube 1524, a fourth distance L4 between the fourth sub-tube 1524 and the fifth sub-tube 1525, a fifth distance L5 between the fifth sub-tube 1525 and the sixth sub-tube 1526, a sixth distance L6 between the sixth sub-tube 1526 and the seventh sub-tube 1527, a seventh distance L7 between the seventh sub-tube 1527 and the eighth sub-tube 1528, and an eighth distance L8 between the eighth sub-tube 1528 and the firth sub-tube 1521 may be the same.

As described above, since the diameter D2 of each of the sub-tubes 1520 is different from the diameter D1 of the main tube 1510, and at the same time, the first to eighth distances L1, L2, L3, L4, L5, L6, L7, and L8 are the same, the phases of the combustion vibration may be different, and at the same time, the structure of the cluster 1500 may be simplified. As the structure of the cluster 1500 becomes simpler, the injection speed, combustion speed, the distribution of flame and the flame temperature of the fuel injected from the main tube 1510 and the sub-tubes 1520 may be reduced. Accordingly, the operation of the combustor 1200 according to the fuel combustion may be adjusted as needed.

In addition, since the sub-tubes 1520 are spaced apart at regular intervals as above, the concentration of fuel injected from the cluster 1500 may be evenly distributed and flashback due to the high concentration of fuel may be prevented.

Referring to FIG. 6, the main tube 1510 of the cluster 1500 according to an embodiment of the present disclosure may be disposed by deviating in one direction from the center of the cluster 1500. Since the center of the main tube 1510 deviates in one direction from the center of the cluster 1500, the phase of the combustion vibration occurring due to the combustion of fuel injected from the main tube 1510 and the phase of the combustion vibration occurring due to the combustion of fuel injected from the sub-tubes 1529 may not have the same value. Accordingly, it is possible to further prevent amplification of amplitude of the combustion vibration occurring due to the merger of the same phases of combustion vibration.

Hereinafter, a combustion nozzle 1230 according to a second embodiment of the present disclosure will be described.

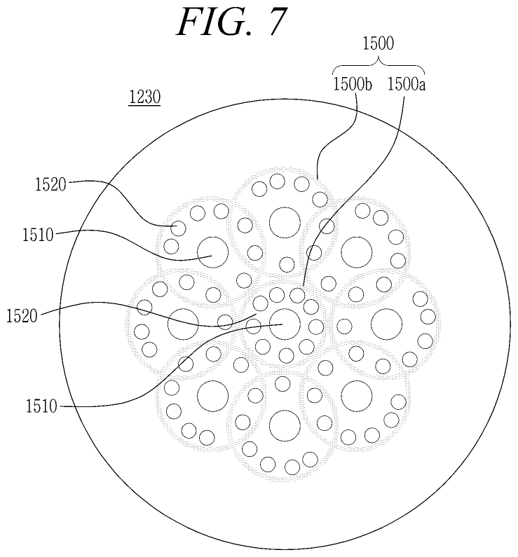

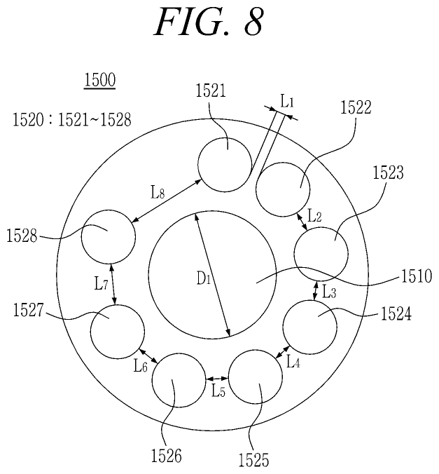

FIG. 7 is an enlarged view illustrating the combustor nozzle according to the second embodiment of the present disclosure, and FIG. 8 is an enlarged view illustrating a cluster of FIG. 7.

Referring to FIGS. 7 and 8, the combustor nozzle 1230 according to the second embodiment has the same structure as the combustor nozzle 1230 according to the first embodiment, except for the arrangement of the sub-tubes 1520, so a repeated description of the same configuration will be omitted.

According to the present embodiment, at least one of the distances L1, L2, L3, L4, L5, L6, L7, and L8 between pairs of adjacent sub-tubes 1520 may be different from another. For example, the distances L1, L2, L3, L4, L5, L6, L7, and L8 between pairs of adjacent sub-tubes 1520 may increase along a clockwise or counterclockwise direction. If the diameters of the sub-tubes 1520 are the same and the distances L1, L2, L3, L4, L5, L6, L7, and L8 between adjacent sub-tubes 1520 are the same, the phases of the combustion vibration according to the combustion of fuel injected from the sub-tubes 1520 may be the same. Accordingly, there may be a possibility for amplification of combustion vibration due to a phase merger of the same phases.

If the distances L1, L2, L3, L3, L4, L6, L7, and L8 between adjacent sub-tubes 1520 are different as shown in the present embodiment, the phase merger of the same phases may be reduced so that the combustion vibration cannot be amplified. However, if the distances L1, L2, L3, L4, L5, L6, L7, and L8 between adjacent sub-tubes 1520 are different, the structure of the cluster 1500 becomes complicated and uncertainty of injection speed, combustion speed, flame distribution, and flame temperature of the injected fuel may increase.

In addition, the concentration of the fuel injected from the cluster 1500 may be uneven and there may be a possibility for flashback due to the high concentration of fuel. Accordingly, it may be difficult to control the operation of the combustor 1200 according to the fuel combustion.

Accordingly, this problem can be solved by arranging the sub-tubes such that the distances L1, L2, L3, L4, L5, L6, L7, and L8 between adjacent sub-tubes 1520 regularly increase along a clockwise or counterclockwise direction. For example, when the sub-tubes are arranged such that the distance between the adjacent sub-tubes increase at a constant rate or by a constant value along the clockwise or counterclockwise direction and the first distance L1 has a smallest value, it is possible to reduce uncertainty of injection speed, combustion speed, flame distribution, and flame temperature of the injected fuel, compared to the case in which the sub-tubes are arranged such that the distances L1, L2, L3, L4, L5, L6, L7, and L8 between adjacent sub-tubes 1520 are different to each other.

In addition, if the sub-tubes 1520 are arranged in the clusters 1500 with regularity so that the clusters 1500 are arranged such that the sub-tubes 1520 are disposed to be relatively uniform in the density, flashback due to the high concentration of fuel can be prevented.

Hereinafter, a cluster 1500 according to a third embodiment of the present disclosure will be described.

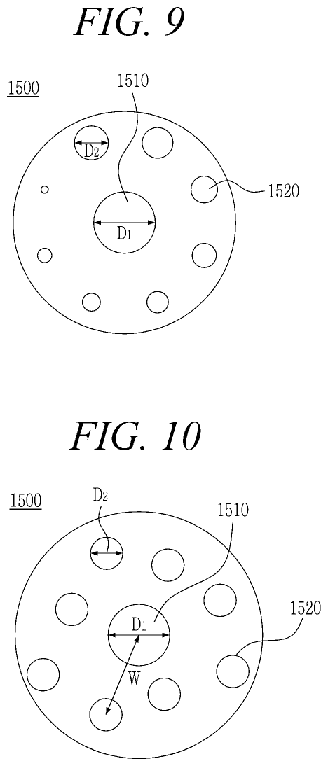

FIG. 9 is a view illustrating the cluster according to the third embodiment of the present disclosure.

Referring to FIG. 9, the cluster 1500 according to the third embodiment is the same structure as the cluster 1500 according to the first embodiment, except for the diameters of the sub-tubes 1520, so a repeated description of the same configuration will be omitted.

According to the present embodiment, the diameters D2 of the sub-tubes 1520 may be different to each other. Since the diameters D2 of the sub-tubes 1520 are different from each other and from the diameter D1 of the main tube 1510, the amplification of vibration amplitude occurring by the merge of the same phases of the combustion vibration according to the fuel combustion may be prevented due to different phases. As the phases of the combustion vibration are different, the phases may be offset together, thereby reducing the amplification of amplitude and the combustion instability.

However, if the diameters D2 of the plurality of sub-tubes 1520 have different values, the structure of the cluster 1500 becomes complicated to increase uncertainty of injection speed, combustion speed, flame distribution, and flame temperature of the injected fuel. In addition, the concentration of the fuel injected from the cluster 1500 may be uneven, so that the fuel is uniformly collected in one side of the cluster 1500, and damage to the cluster 1500 caused by the flashback may occur.

Thus, the diameters D2 of the sub-tubes 1520 may decrease along a clockwise or counterclockwise direction. If the diameters D2 of the sub-tubes 1520 decrease at a constant rate or by a constant value along the clockwise or counterclockwise, it is possible to reduce uncertainty of a combustion condition such as injection speed, flame distribution, and flame temperature of the injected fuel, compared to the case in which the sub-tubes are arranged such that the diameters of the sub-tubes 1520 are different to each other.

In addition, since the sub-tubes 1520 are arranged in the clusters 1500 with regularity so that the clusters 1500 are arranged such that the sub-tubes 1520 are disposed to be relatively uniform in the density of fuel injected from the sub-tubes, thereby preventing the density of the fuel from being partially increased.

Hereinafter, a cluster 1500 according to a fourth embodiment of the present disclosure will be described.

FIG. 10 is a view illustrating the cluster according to the fourth embodiment of the present disclosure.

Referring to FIG. 10, the cluster 1500 according to the fourth embodiment has the same structure as the cluster 1500 according to the first embodiment, except for the arrangement of the sub-tubes 1520, so a repeated description of the same configuration will be omitted.

According to the present embodiment, at least one distance W from the center of the main tube 1510 to the centers of the sub-tubes 1520 may be different to another. For Example, distances W from the center of the main tube 1510 to the centers of the sub-tubes 1520 may be different to each other. Since the distances W from the center of the main tube 1510 to the centers of the sub-tubes 1520 are not constant, the amplification of vibration amplitude obtained by the merge of the same phases of the combustion vibration according to the fuel combustion may be prevented due to different phases. As the phases of the combustion vibration are different, the phases are offset together, thereby reducing the amplification of amplitude and the combustion instability.

However, if the distances W from the center of the main tube 1510 to the centers of the sub-tubes 1520 have different values, the structure of the cluster 1500 becomes complicated and uncertainty of a combustion condition such as flame distribution, flame temperature, or the like may increase. Accordingly, the distances W from the center of the main tube 1510 to the centers of the sub-tubes 1520 may be changed as necessary.

For example, the distances W from the center of the main tube 1510 to the centers of the sub-tubes 1520 may increase or decrease at a constant rate or by a constant value along a clockwise or a counter-clockwise. For another example, the distances W from the center of the main tube 1510 to the centers of the sub-tubes 1520 may alternately increase and decrease at a constant rate. As the sub-tubes 1520 are arranged in this way, the density of the fuel injected from the sub-tubes 1520 may be relatively uniform to prevent the density of the fuel from being partially increased.

While the embodiments of the present disclosure have been described, it will be apparent to those skilled in the art that various modifications and variations can be made in the present disclosure through addition, change, omission, or substitution of components without departing from the spirit of the invention as set forth in the appended claims, and such modifications and changes may also be included within the scope of the present disclosure. Also, it is noted that any one feature of an embodiment of the present disclosure described in the specification may be applied to another embodiment of the present disclosure.

1. A combustor nozzle comprising:
at least one cluster composed of a plurality of tubes through which air and fuel flow,
wherein the cluster comprises:
a main tube through which the air and fuel flows; and
a plurality of sub-tubes disposed to surround the main tube,
wherein a diameter of the main tube and a diameter of at least one of the plurality of sub-tubes are different.

2. The combustor nozzle according to claim 1, wherein the cluster is composed of a central cluster and at least one peripheral cluster placed to surround the central cluster.

3. The combustor nozzle according to claim 1, wherein the diameter of the main tube is 2-5 times the diameter of the at least one of the plurality of sub-tubes.

4. The combustor nozzle according to claim 1, wherein the plurality of sub-tubes have the same diameter.

5. The combustor nozzle according to claim 1, wherein distances between pairs of adjacent sub-tubes of the plurality of sub-tubes are the same.

6. The combustor nozzle according to claim 1, wherein the center of the main tube deviates in one direction from the center of the cluster.

7. The combustor nozzle according to claim 1, wherein the distances between pairs of adjacent sub-tubes of the plurality of sub-tubes increase along a clockwise or counterclockwise direction.

8. The combustor nozzle according to claim 1, wherein the plurality of sub-tubes have different diameters.

9. The combustor nozzle according to claim 8, wherein the diameters of the plurality of sub-tubes decrease along a clockwise or counterclockwise direction.

10. The combustor nozzle according to claim 1, wherein the distances from the center of the main tube to the centers of the plurality of sub-tubes are different.

11. A gas turbine comprising:
a compressor configured to compress air introduced from the outside;
a combustor having a combustor nozzle and configured to mix the compressed air compressed in the compressor and fuel and combust an air-fuel mixture; and
a turbine including a plurality of turbine blades to be rotated by combustion gases combusted in the combustor, the combustor nozzle comprising:
at least one cluster composed of a plurality of tubes through which air and fuel flow,
wherein the cluster comprises:
a main tube through which the air and fuel flows; and
a plurality of sub-tubes disposed to surround the main tube,
wherein a diameter of the main tube and a diameter of at least one of the plurality of sub-tubes are different.

12. The gas turbine according to claim 11, wherein the cluster is composed of a central cluster and at least one peripheral cluster placed to surround the central cluster.

13. The gas turbine according to claim 11, wherein the diameter of the main tube is 2-5 times the diameter of the at least one of the plurality of sub-tubes.

14. The gas turbine according to claim 11, wherein the plurality of sub-tubes have the same diameter.

15. The gas turbine according to claim 11, wherein distances between pairs of adjacent sub-tubes of the plurality of sub-tubes are the same.

16. The gas turbine according to claim 11, wherein the center of the main tube deviates in one direction from the center of the cluster.

17. The gas turbine according to claim 11, wherein the distances between pairs of adjacent sub-tubes of the plurality of sub-tubes increase along a clockwise or counterclockwise direction.

18. The gas turbine according to claim 11, wherein the plurality of sub-tubes have different diameters.

19. The gas turbine according to claim 18, wherein the diameters of the plurality of sub-tubes decrease along a clockwise or counterclockwise direction.

20. The gas turbine according to claim 11, wherein the distances from the center of the main tube to the centers of the plurality of sub-tubes are different.
